(19) United States
(12) Patent Application Publication
(10) Pub. No.: US 2017/0265053 A1
(43) Pub. Date: Sep. 14, 2017

(54) Method and Apparatus for Discovering Network Devices

(71) Applicant: CA, Inc., New York, NY (US)

(72) Inventors: Bryan Diebold, Shrewsbury, MA (US); Sumeet Garg, Westborough, MA (US)

(21) Appl. No.: 15/065,974

(22) Filed: Mar. 10, 2016

(51) Int. Cl. H04W 8/00; H04L 29/08; H04W 76/02; H04L 29/06

(52) U.S. Cl. CPC H04W 8/005; H04L 69/18; H04L 67/303; H04L 69/08; H04W 76/023

(57) ABSTRACT

A monitoring computer automatically identifies and communicates with one or more network-based devices to determine metric information collected and stored by those devices. The monitoring computer performs these functions even in cases where it does not know how to retrieve the information it needs to monitor a given network device, or even initially communicate with the device. Particularly, the monitoring computer autonomously determines the information needed to communicate with the devices and retrieve measurement data collected by those devices, and then uses that information and data to identify the device and subsequently configure itself to monitor that device.

### BACKGROUND

The present disclosure relates generally to processes for discovering devices connected to a communications network.

There is a general need for users to understand the various devices that are available or are connected to a communications network. Typically, these devices are IP-based, and comprise different types of devices such as air conditioners, computer servers, power supplies, mass storage devices, and the like. There are a variety of tools available to monitor and obtain metrics information from these devices (e.g., power usage, energy consumption, temperature) so that users can ensure that the devices are working properly. However, not all of the devices come from a single vendor. In many cases, the devices are provided by a variety of different vendors and manufacturers. Further, existing tools are tied to the various protocols and coding specific to the respective vendors that manufacture the devices. Thus, whenever a new device is added to the network, the coding of a given tool must be modified to enable that tool to monitor and communicate with that device.

Additionally, it is not always easy or intuitive to interpret whatever information and data is output by the tool. Currently, for example, users must visually analyze a data dump of a device and manually determine how to query the device for its metric information before actually executing the query. Such processes are labor intensive and error prone. Further each different device may use different data points to reflect different metrics, and store them in different areas of memory. Because different vendors use, inter alia, different protocols for storing and retrieving the data, there is no easy way to determine the particular area of memory for a given device so that specific metrics information can be retrieved. Users must determine that information from the manufacturer's specification sheets, and then alter the coding of the monitoring tool for that particular device based on that specification.

### BRIEF SUMMARY

Embodiments of the present disclosure provide a tool that automatically communicates with a variety of different IP-based devices communicatively linked to an IP-based communications network, and extract metrics information from those devices. The monitoring tool may be a part of a larger set of tools, or a standalone tool, but is configured to identify the various devices on the network regardless of the manufacturer of the device. Particularly, the monitoring tool of the present embodiments is configured to find and retrieve the metrics information from the various devices even though the tool may not be preconfigured to retrieve the metrics information it needs to monitor the device.

In one embodiment, the present disclosure provides a method that is implemented in a network monitoring device, such as a monitoring computer, for example. In this embodiment, the method calls for identifying a protocol for communicating with a device communicatively connected to a communications network. Particularly, identifying the protocol comprises sending a request message to a plurality of IP addresses using a plurality of different protocols, wherein each IP address is within a predetermined range of IP addresses, and wherein one of the plurality of IP addresses is assigned to the device, and identifying the protocol based on a response message received from the device. The method then calls for determining, based on information received in the response message, a memory location at the device that stores metrics data collected by the device. The metrics data collected by the device is retrieved from that memory location, analyzed, and used to determine an identity of the device based on the analysis.

In another embodiment, the present disclosure provides a computing device, such as a monitoring computer. The computing device comprises a communications interface circuit and a processing circuit. The communications interface circuit is configured to communicate data with a plurality of devices connected to a communications network. The processing circuit is configured to receive a message from a first device via the communications interface circuit, wherein the message comprises information indicating a memory location storing metrics data collected by the first device, identify a protocol for communicating with the first device responsive to receiving the message, retrieve the metrics data collected by the first device from the memory location, and determine an identity of the first device based on an analysis of the metrics data retrieved from the first device.

Another embodiment of the present disclosure provides a computer readable storage medium comprising computer executable code that, when executed by a processing circuit of a computing device, configures the processing circuit to send a request message via a communications network to a destination IP address, wherein the request message is formatted according to a selected protocol, and determine whether a device associated with the destination IP address has sent a response message in response to the request message, wherein the response message comprises information indicating a memory location at the device. If the device associated with the destination IP address has sent a response message, the computer executable code configures the processing circuit to retrieve metrics data from the memory location at the device, wherein the metrics data comprises data points representing selected operating parameters and are collected and stored by the device, identify the selected protocol used to format the request message as being a protocol for use in communicating with the device, and determine an identity of the device based on the metrics data retrieved from the memory location at the device.

Of course, those skilled in the art will appreciate that the present embodiments are not limited to the above contexts or examples, and will recognize additional features and advantages upon reading the following detailed description and upon viewing the accompanying drawings.

### BRIEF DESCRIPTION OF THE DRAWINGS

Aspects of the present disclosure are illustrated by way of example and are not limited by the accompanying figures with like references indicating like elements.

FIG. 1 is a block diagram illustrating some components of a computer system configured according to one embodiment of the present disclosure.

FIG. 2 is a flow diagram illustrating a method for configuring a monitoring circuit according to one embodiment of the present disclosure.

FIG. 3A is a flow diagram illustrating method for determining a protocol with which to communicate with a device according to one embodiment of the present disclosure.

FIGS. 3B-3C are flow diagrams illustrating methods for determining an identity of a device according to embodiments of the present disclosure.

FIG. 4 is a flow diagram illustrating a method for identifying memory addresses at a device, and data that may be stored at those memory addresses, according to one embodiment of the present disclosure.

FIG. 5 is a block diagram illustrating some functional components of a monitoring device configured according to one embodiment of the present disclosure.

### DETAILED DESCRIPTION

As will be appreciated by one skilled in the art, aspects of the present disclosure may be illustrated and described herein in any of a number of patentable classes or context including any new and useful process, machine, manufacture, or composition of matter, or any new and useful improvement thereof. Accordingly, aspects of the present disclosure may be implemented entirely as hardware, entirely as software (including firmware, resident software, micro-code, etc.) or combining software and hardware implementation that may all generally be referred to herein as a “circuit,” “module,” “component,” or “system.” Furthermore, aspects of the present disclosure may take the form of a computer program product embodied in one or more computer readable media having computer readable program code embodied thereon.

Any combination of one or more computer readable media may be utilized. The computer readable media may be a computer readable signal medium or a computer readable storage medium. A computer readable storage medium may be, for example, but not limited to, an electronic, magnetic, optical, electromagnetic, or semiconductor system, apparatus, or device, or any suitable combination of the foregoing. More specific examples (a non-exhaustive list) of the computer readable storage medium would include the following: a portable computer diskette, a hard disk, a random access memory (RAM), a read-only memory (ROM), an erasable programmable read-only memory (EPROM or Flash memory), an appropriate optical fiber with a repeater, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

A computer readable signal medium may include a propagated data signal with computer readable program code embodied therein, for example, in baseband or as part of a carrier wave. Such a propagated signal may take any of a variety of forms, including, but not limited to, electro-magnetic, optical, or any suitable combination thereof. A computer readable signal medium may be any computer readable medium that is not a computer readable storage medium and that can communicate, propagate, or transport a program for use by or in connection with an instruction execution system, apparatus, or device. Program code embodied on a computer readable signal medium may be transmitted using any appropriate medium, including but not limited to wireless, wireline, optical fiber cable, RF, etc., or any suitable combination of the foregoing.

Computer program code for carrying out operations for aspects of the present disclosure may be written in any combination of one or more programming languages, including an object oriented programming language such as Java, Scala, Smalltalk, Eiffel, JADE, Emerald, C++, C#, VB.NET, Python or the like, conventional procedural programming languages, such as the “C” programming language, Visual Basic, Fortran 2003, Perl, COBOL 2002, PHP, ABAP, dynamic programming languages such as Python, Ruby and Groovy, or other programming languages. The program code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider) or in a cloud computing environment or offered as a service such as a Software as a Service (SaaS).

Aspects of the present disclosure are described herein with reference to flowchart illustrations and/or block diagrams of methods, apparatuses (systems) and computer program products according to embodiments of the disclosure. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable instruction execution apparatus, create a mechanism for implementing the functions/acts specified in the flowchart and/or block diagram block or blocks.

These computer program instructions may also be stored in a computer readable medium that when executed can direct a computer, other programmable data processing apparatus, or other devices to function in a particular manner, such that the instructions when stored in the computer readable medium produce an article of manufacture including instructions which when executed, cause a computer to implement the function/act specified in the flowchart and/or block diagram block or blocks. The computer program instructions may also be loaded onto a computer, other programmable instruction execution apparatus, or other devices to cause a series of operational steps to be performed on the computer, other programmable apparatuses or other devices to produce a computer implemented process such that the instructions which execute on the computer or other programmable apparatus provide processes for implementing the functions/acts specified in the flowchart and/or block diagram block or blocks.

Embodiments of the present disclosure provide a tool that is configured to automatically identify and communicate with one or more network-based devices to determine metric information collected and stored by those devices. The tool, which is implemented by a computing device, may be a standalone application or be part of another application executing on the computing device. Regardless, the tool of the present disclosure is especially configured to discover and identify network-based devices for which the tool must monitor, but does not know how to retrieve the information it needs to monitor the device. In some cases, the tool may not initially understand how to even communicate with the device. However, the tool configured according to the present embodiments need not know this information a priori. Rather, the tool of the present embodiments is configured to autonomously determine such information, and then use that information to identify a device and retrieve metrics data from the specific portion of memory at the device in which the data is stored.

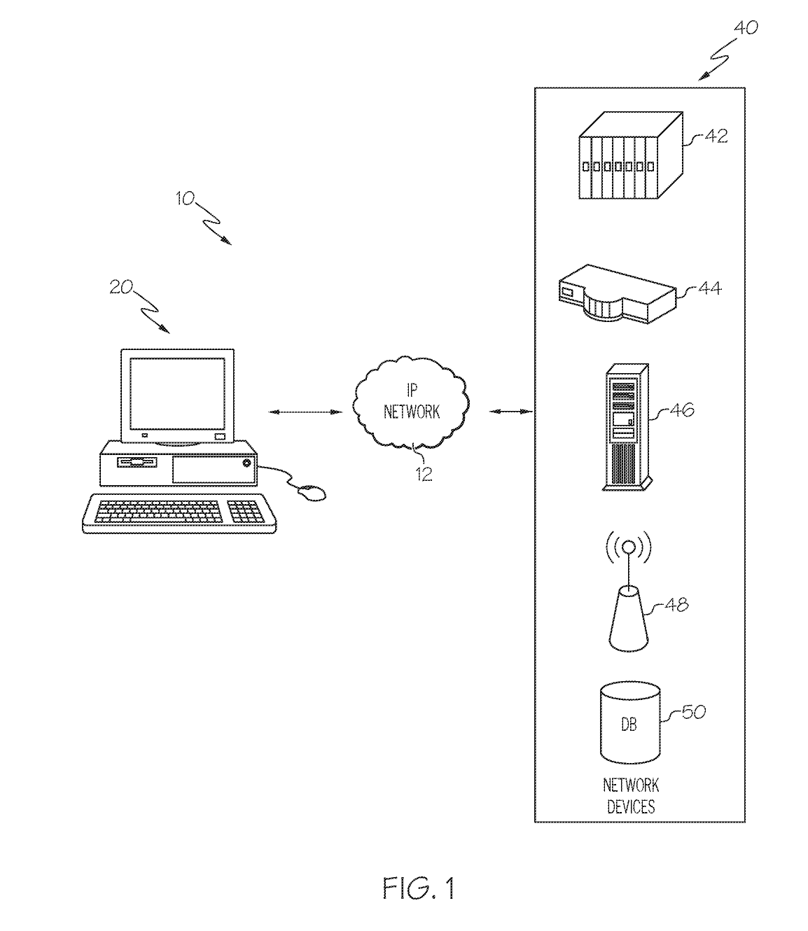

Turning now to the drawings, FIG. 1 is a block diagram illustrating some components of a communications system 10 configured according to one embodiment of the present disclosure. As those of ordinary skill in the art will readily appreciate, the components seen in FIG. 1 are illustrative only. Thus, a communications system 10 suitable for configuration according to the present embodiments may comprise more or fewer components as needed or desired, or in some cases, components that are different than those illustrated in FIG. 1.

Communications system 10 comprises an IP network 12 communicatively connecting monitoring computer (or terminal) 20 with one or more IP-based network devices 40. Network 12 may comprise one or more public and/or private wireless and/or wired communications networks, and thus, may communicate data using any protocol known in the art. In at least one embodiment, however, network 12 communicates data between the monitoring computer 20 and one or more of the network devices 40 using one or more well-known protocols such as TCP/IP, 802.xx, WiFi, and the like.

The networked devices 40 include, but are not limited to, various devices such as one or more racks of network cards 42, routers 44, application servers (ASs) 46, access nodes 48, and mass storage devices 50. Other suitable devices include, for example, switches, modems, communication devices (e.g., phones, tablets), applications running on one or more servers, and the like. Generally, network devices 40, such as those seen in FIG. 1, comprise a user's network, and as such, are monitored from time-to-time to ensure their health and/or performance. For example, these devices are usually configured to take and collect measurements of their internal and/or external environments periodically, and then store those measurements as metrics data in a memory circuit.

Typically, an operator or tool must communicate with a given device to retrieve the metrics data. However, this requires the operator to know of the existence of the device on the network a priori, as well as some specifics with which the measurements are collected and stored by the device. That is, with conventional systems, the operator must know how to communicate with the device (e.g., what protocols are used), where in a memory the metrics data is stored, how often the metrics data is collected and stored in the memory, and the like. Armed with this information, the operator can pre-configure a monitoring tool to periodically retrieve the metrics data. However, as stated above, such conventional methods require operators to manually configure their tools with information gleaned from the device's specification manuals. Further, with conventional methods, operators may be required to cease monitoring operations for an appreciable amount of time until their tool is properly configured to monitor one or more given devices.

Therefore, as described in more detail below, the monitoring computer 20 is configured according to one or more embodiments to automatically discover and identify one or more of the network devices 40 even in cases where the monitoring computer 20 does not initially know how to communicate with any given network device 40. Once discovered, the monitoring computer 20 of the present disclosure automatically determines how to communicate with the device(s) 40 so that it could exchange information with the device(s) 40. Based on the exchanged information, the tool of the present disclosure identifies the network device(s) 40, identifies the memory location(s) in which it stores its collected metrics data, and retrieves the metrics data from that memory location. Thereafter, based on an analysis of that metrics data, the monitoring computer 20 configures itself to, over time, periodically retrieve and analyze subsequent metrics data collected and stored by the network device(s) 40. As those of ordinary skill in the art will appreciate, the retrieved metrics data may be used to monitor the health and performance of the network device(s) 40.

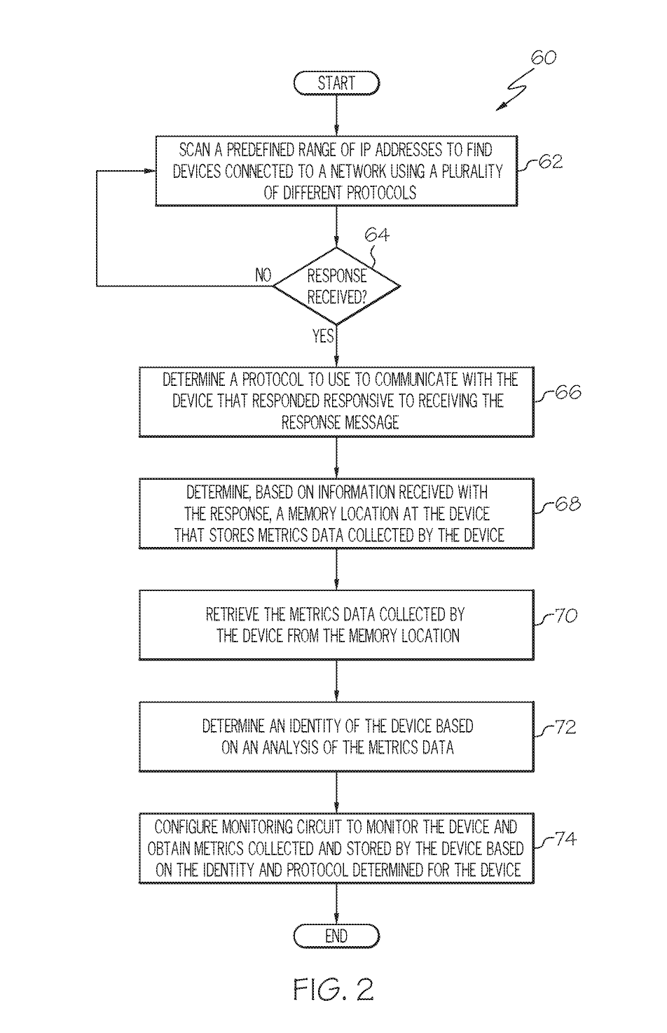

FIG. 2 is a flow diagram illustrating a method 60 for configuring a monitoring circuit, such as monitoring computer 20, to identify and collect metrics data from network devices 40 according to one embodiment of the present disclosure. The method 60 is performed (i.e., implemented at) the monitoring computer 20 and begins with the monitoring computer 20 scanning a predefined range of IP addresses (box 62). This may be accomplished any number of ways, but in one embodiment, the monitoring computer 20 utilizes a “request-response” mechanism to discover whether any devices 40 are connected to the IP network 12.

The requests are sent “blindly” to various selected IP addresses within the range of IP addresses using one or more selected known protocols. The protocols identify, for example, one or more commands, message formats, and the like, to use in at least initially connecting with a given device 40. Further, each protocol is associated with one or more port numbers. The port numbers, which are included in the requests to the devices, identify possible ports over which the device may be configured to receive data from the network. The idea is that devices 40 having the IP address and associated port(s) used in the request message, and that communicate according to the protocol used to send the request message, will respond to the request message (box 64). However, if no devices 40 respond to the request within a predefined time period, for example, the monitoring computer 20 may generate and send another request message using a different IP address, port(s), and/or selected protocol.

Typically, network devices 40 that do respond to the request message will respond with at least a minimum amount of information. The identity and other specifics of the device 40 may still be unknown. However, from the response message, the monitoring computer 20 is able to identify at least the protocol with which the device communicates, as well as at least one port over which the device communicates (box 66).

In some cases, one or more of the network devices 40 may have sub-devices, each of which may also be associated with a corresponding IP address(s), port(s), and/or protocol(s). In these cases, the devices 40 that respond to a given request message may also provide information regarding those sub-devices. So informed, embodiments of the present disclosure are also configured to communicate with these sub-devices, and retrieve metrics data from these sub-devices, as described herein below.

Once the protocol has been determined, the monitoring device 20 then identifies a memory location accessible to the device 40 that stores the metrics data collected by the device 40 (box 68). This may be accomplished, for example, by analyzing the information returned with the response message, if any. For example, information returned with the response message may expressly identify a memory address accessible to the device 40 that stores the metrics data. In another example, the information may identify a plurality of different types of metrics data stored at the device 40, along with a memory address for each different type of metrics data. Using information returned with the response message, the monitoring computer 20 can, as described in more detail below, generate the commands and/or messages needed to retrieve the particular metrics data from the device 40.

Alternatively, in cases where the responding device 40 does not expressly provide such memory address locations, the monitoring computer 20 may utilize the information provided in the response message to generate and send another message or command to the device 40, using the identified protocol, to explicitly request the memory location(s) of the metrics data.

Regardless of how the memory location(s) are obtained, however, the monitoring computer 20 will the retrieve a data dump of the metrics data at the specified memory address (box 70). For example, in one embodiment, the monitoring computer 20 generates and sends a command or message to the device 40 to cause that device to retrieve a selected set of metrics data from the identified memory location at device 40. Such metrics may comprise, or be related to, any measurement values needed or desired (e.g., temperature, power usage, transmission rates, error rates, and the like), and are referred to as “data points.” Once retrieved, the monitoring computer 20 can analyze these “data points,” and use that analysis to determine an identity of the device 40 (box 72).

For example, monitoring computer 20 may store historical measurements of a device 40, or a given type of device 40, in memory. By comparing the data points retrieved from the device 40 to corresponding data points stored in memory, the monitoring computer 20 is able to determine which type of device 40 it is communicating with, as well as the specific identity of the device. Once this information is known, which is indicating by a “match,” the monitoring computer 20 can configure itself to monitor that device 40 by periodically retrieving the metrics data from the memory location(s) at device 40 (box 74).

In one embodiment, a “match” might be based on the results of a comparison between the types of information found in a particular register in device memory. For example, if a device stores temperature information in a certain register, a match might be found if a stored profile for a known device reflects temperature information stored in that register. Alternatively, or additionally, a “match” might be based on the particular values of a parameter in the device memory and those in the device profile. In some embodiments, one or both of these comparisons may further be qualified using a threshold value (e.g., is the data point read from the device far too large or far too small when compared with the stored profile data point, or is the data point read from the device memory within a certain acceptable range of a stored profile data point). A score may be computed based on the number of matching parameters, and based on the score, the monitoring computer 20 determines whether a match is present and the device is known. Once the device 40 is known, the monitoring computer 20 can configure itself using known specifications to monitor the device and retrieve data, as previously described.

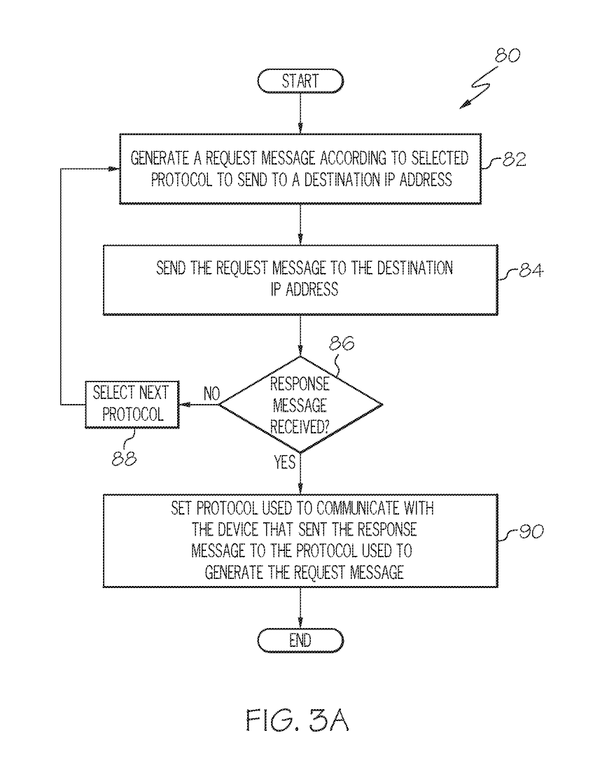

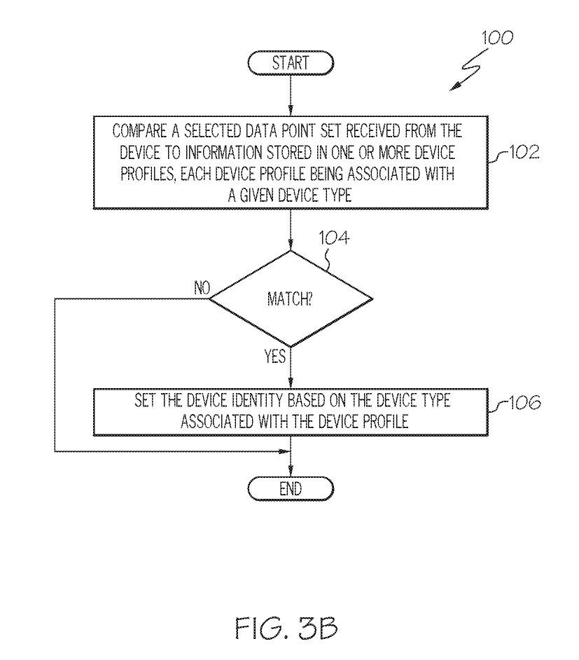

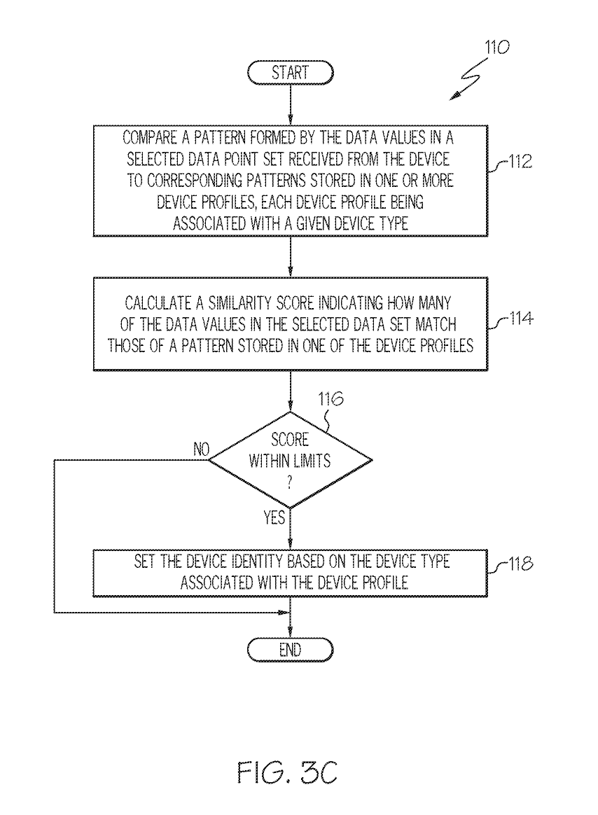

As previously stated, there are a variety of ways to determine which protocol must be used to communicate with a given device 40. FIG. 3A, for example, is a flow diagram illustrating a method 80 for determining that protocol according to one embodiment of the present disclosure. Particularly, with this embodiment, the monitoring computer 20 is preconfigured with a range of one or more predefined IP addresses. The IP addresses that fall in the predetermined range comprise a “pool” of IP addresses that may or may not be assigned to the various network devices 40 when they are added to the network. The monitoring computer 20 may also be configured with a range of one or more known protocols, which can be used to communicate data and information with various network devices 40. For example, such protocols may identify one or more commands, message formats, and the like, that may be used to at least initially connect with a given device 40. The information identifying the IP address range and/or the various protocols may be stored in a memory as one or more configuration files.

According to this embodiment, the monitoring computer 20 first generates a request message according to a first known selected protocol (box 82), and then sends that request message “blindly” to a selected IP address through the network (box 84). As previously stated, the request message also comprises one or more port numbers at the device over which the device may communicate data with the network. The idea is that if the monitoring computer 20 receives a response message (box 86), it must have come from a device having the known IP address and that can communicate over the one or more port numbers using the known protocol. From this, the monitoring computer 20 sets the protocol with which to communicate with the responding device 40 to be the protocol that was used to generate the corresponding request message (box 90). If the monitoring computer 20 does not receive a response message, however (box 86), monitoring computer 20 selects another protocol from the known pool of protocols, and repeats the process by formatting the request message according to that newly-selected protocol.

As stated above, the request message that is sent using the selected protocol may be sent to a plurality of different IP addresses identified within the pool of IP addresses. Therefore, the embodiment seen in FIG. 3A may be applied to one or more of the plurality of IP addresses.

FIG. 3B is a flow diagram illustrating a method 100 for determining the identity of a device 40 according to embodiments of the present disclosure. This embodiment utilizes a comparison of the data point values that are retrieved from the memory location accessible to the device 40. Additionally, method 100 assumes that the monitoring computer 20 has already obtained the metrics data (i.e., the data point values) from the memory location(s) accessible to the device 40, and stores one or more reference data point values in memory. The reference data point values may be stored, for example, in one or more device profiles, each of which is associated with a given device type.

As seen in FIG. 3B, method 100 begins with the monitoring computer 20 comparing a selected set of data point values (i.e., a data point set) retrieved from the device 40 to one or more data point sets that are stored in memory (box 102). The data point sets may comprise, for example, a set of data values that are associated with a given measurement performed by device 40. By way of example only, a data point set may comprise a set of temperature or power usage values measured by device 40 over some defined period of time.

Reference data point sets are stored as corresponding device profiles by the monitoring computer 20, and are used in a comparison with the selected data point set retrieved from the device 40. That is, specific devices 40 and types of devices 40 have known or expected measurement values. If there is a match between the two data point sets (box 104), the monitoring computer 20 can set the identity of the device 40 to whatever identity corresponds to the reference data set (box 106). Otherwise, the method 100 ends.

As above, there is no need for an exact match with the present embodiments although exact matches are helpful. A match may be qualified using one or more threshold values to ensure that one or more of the values retrieved from the device 40 are neither too large nor too small when compared with the stored reference data points. Alternatively, or additionally, a match may be qualified by ensuring that data point value(s) read from the device 40 is within a certain acceptable range of stored reference data point value(s). As above, a score may be computed based on the number of matching data point values (e.g., a simple ratio), and based on that score, the monitoring computer 20 can set the device identity to the identity that corresponds to the reference data point value(s).

As stated previously, the data point sets may be thought of as “patterns” of data values. Thus, the identity of a given device 40 may also be determined based on the pattern of data point values that are retrieved from its memory. FIG. 3C is a flow diagram illustrating a method 110 for determining an identity of a network device 40 based on such patterns according to one such embodiment of the present disclosure.

Method 110 begins with the monitoring computer 20 comparing a pattern formed by the data values in a selected data point set obtained from device 40 to one or more corresponding patterns stored in one or more device profiles (box 112). As above, each device profile corresponds to an associated type of device 40. Based on the comparison, the monitoring computer 20 then computes a “similarity score” indicating how many of the data point values in the selected data point set match those stored in a given device profile (box 114). As previously stated, the similarity score may be “qualified.” Thus, if a given similarity score is within limits (box 116), the monitoring computer 20 can set the identity of the device 40 to the device identity that is associated with the device profile (box 118).

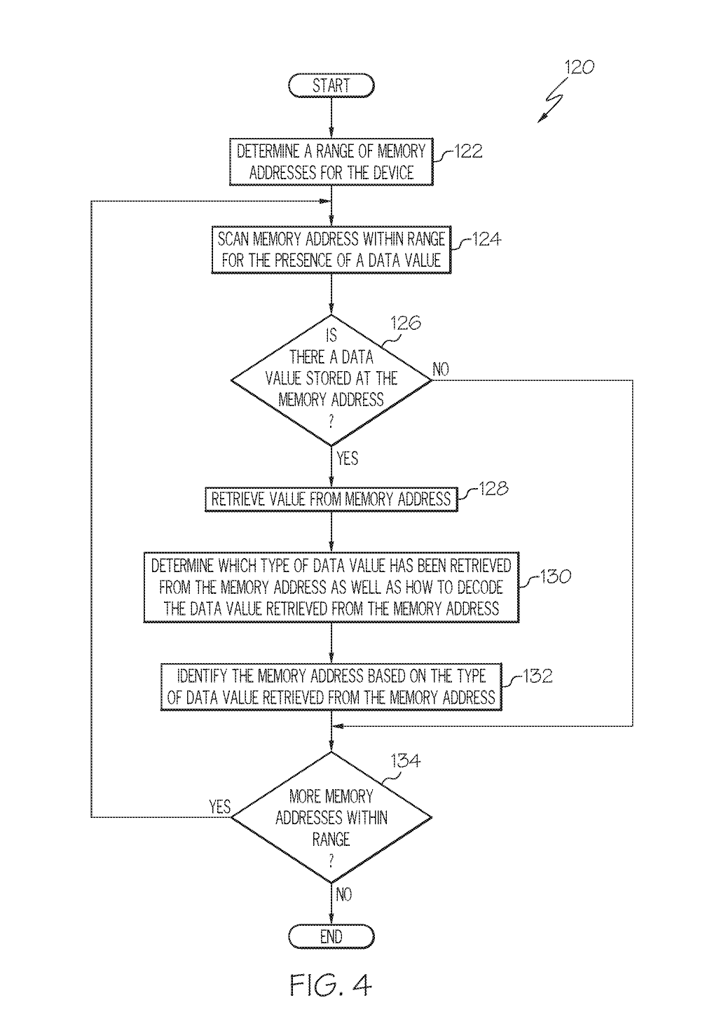

As previously stated, the identity of a given device may be determined by an analysis of the data values that it stores in its memory. More specifically, different devices typically store different data values at different memory addresses. These data values, which may be of any data type (e.g., integer, floating point, hex, bit, byte, string, records, etc.), may correspond to particular measurements performed by the device. For example, a given device may periodically perform both a power measurement and a temperature measurement. In one embodiment, the device stores the measured power value at a first memory address, and the measured temperature value at a second memory address. Identifying the memory addresses from which to retrieve the data values, as well as the data type and how that data is to be interpreted (e.g., to which type of measurement does it belong), is not always known a priori, making it difficult to identify the device. Therefore, method 120 seen in FIG. 4 provides one way in which the monitoring computer 20 is able to retrieve and analyze the information for use in identifying the device that stored the data values.

As seen in FIG. 4, method 120 begins with the monitoring computer 20 determining a range of one or more memory addresses for the device (box 122). By way of example only, monitoring computer 20 may store a plurality of valid memory address ranges for one or more different devices. To determine a memory address range, monitoring computer 20 could select a range from the plurality of ranges. Such selection may be arbitrary, or based on some known variable or parameter associated with the device. Alternatively, the memory address range(s) may be provided by a user of monitoring computer 20 via an input device. In one embodiment, the monitoring computer 20 generates and sends a request message to the device requesting that the device provide the range of memory addresses, and receives the range of memory addresses from the device.

Regardless of how the monitoring computer 20 determines the range of memory addresses, however, monitoring computer 20 scans each memory address within the range of memory addresses to determine whether a data value is stored at that particular memory address (box 124). In some cases, the memory addresses themselves comprise a subset of one or more other memory addresses. In this case, monitoring computer 20 will also scan each of those memory addresses in the subset. If no data values are detected at a given memory address (box 126), method 120 simply advances to the next memory address in the range (box 134). Otherwise, monitoring computer 20 will process the data value that is found at the memory address to determine both its data type, and how to decode the data value.

In more detail, monitoring computer 20 will first retrieve (or copy) the data value from the given memory address (box 128). The monitoring computer then determines a data type for the data value, as well as how to decode the data value (box 130). In this embodiment, the data type for a given data value may be determined using a predetermined function. By way of example only, the predetermined function may be, or operate similar to, the isint( ) function defined in C and C++. Specifically, with this function, the data value retrieved from the memory address is passed as a parameter to the isint( ) function. The isint( ) function, in turn, will then return either a zero (0) if the data value is an integer and a non-zero value if it is not. Similar functions either exist, or can be written, for other data types.

To decode the data value retrieved from the memory address, the monitoring computer 20 can perform any number of one or more checks. For example, in one embodiment, the monitoring computer 20 compares the memory address from which the data value was retrieved to a list of memory addresses stored in a library. Each memory address stored in the library is associated with a corresponding decoding technique. Thus, if a match is found, monitoring computer 20 is able to determine how to decode the data value based on the corresponding decoding technique. In other embodiments, though, monitoring computer 20 can prompt a user to manually identify a particular decoding method for which to decode the data value.

Regardless, the monitoring computer 20 is able to identify the particular memory address from which the data value was retrieved responsive to successfully decoding the data value (box 132). Based on this information, the monitoring computer 20 may be able to identify the particular device. For example, as stated above, certain types of devices store certain data values at predefined memory addresses. Such information is maintained in a memory that is accessible to the monitoring computer 20. By identifying the address location for a particular type of data value and/or for a particular data value, monitoring computer may be able to identify the device.

Of course, more than one data value may be retrieved and analyzed according to the method 120, and utilized to identify the device. The idea is that if multiple data values can be retrieved, analyzed, and understood, the monitoring computer 20 can identify the device that stores those data values with relatively greater certainty.

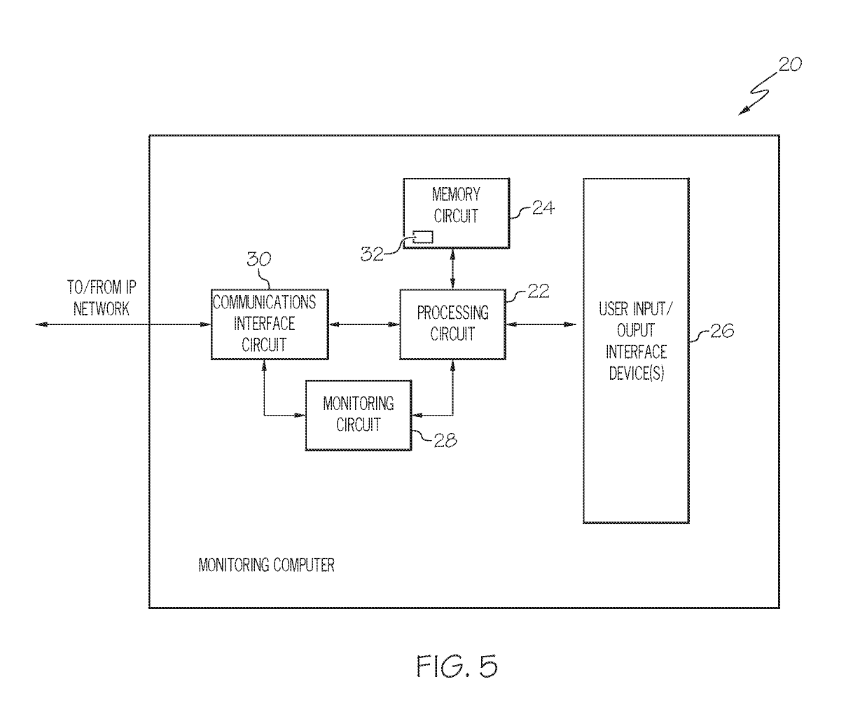

FIG. 5 is a block diagram illustrating some components of a monitoring computer 20 configured according to one embodiment of the present disclosure. The monitoring computer 20 may, as previously stated, comprise a server computer or user terminal, for example, and comprises a processing circuit 22, a memory circuit 24, a user input/output (I/O) interface device(s) 26, a monitoring circuit 28, and a communications interface circuit 30.

Processing circuit 22 may be implemented by circuitry comprising one or more microprocessors, hardware, firmware, or a combination thereof. Generally, processing circuit 22 controls the operation and functions of the monitoring computer 20 according to appropriate standards. Such operations and functions include, but are not limited to, communicating with other network devices, such as one or more network devices 40, via network 12.

Additionally, according to various embodiments of the present disclosure, processing circuit 22 is configured to execute a control application (e.g., control application 32 stored in memory 24) to perform the method of the present disclosure according to the embodiments previously described. Such functions include, but are not limited to, automatically detecting the presence of devices 40, determining a protocol with which to communicate with the devices 40, obtaining metrics data from a memory location accessible to devices 40, identifying the devices 40, and configuring itself to monitor the devices 40 based on this information.

The memory circuit 24 may comprise any non-transitory, solid state memory or computer readable storage media known in the art. Suitable examples of such media include, but are not limited to, ROM, DRAM, Flash, or a device capable of reading computer-readable storage media, such as optical or magnetic storage media. Memory circuit 24 stores programs and instructions, such as the control application 32 that is executed by the processing circuit 22. More specifically, the control application 32 comprises the logic and instructions that, when executed by the processing circuit 22, configures the monitoring computer 20 to perform the functionality previously described.

The user I/O interface 26 comprises the hardware and software components necessary for a user to interact with monitoring computer 20. Such components include, but are not limited to, one or more display devices, keyboards, keypads, a mouse, and any other input/output mechanisms that facilitate the previously described functions according to embodiments of the present disclosure.

The monitoring circuit 28 also comprises the hardware circuitry needed for communicating commands and messages to the various network devices 40, as well as for receiving the metrics data and other information from the network devices 40. In one embodiment, the monitoring circuit 28 comprises a circuit that is separate from the processing circuit 22; however, in other embodiments, the monitoring circuit 28 is part of the circuitry that comprises the processing circuit 22.

The communications interface circuit 30 may comprise one or more ETHERNET cards or other circuitry capable of wireless communications, but is generally configured to facilitate communications with the network device 40 via the IP network 12. Particularly, via the communications interface circuit 30, the monitoring computer 20 receives metrics information from the network device 40, and passes that information to the processing circuit 22. Based on that information, as stated above, the processing circuit 22 can configure the monitoring circuit 28 to monitor the network devices 40.

The present embodiments may, of course, be carried out in other ways than those specifically set forth herein without departing from essential characteristics of the disclosure. For example, it should be noted that the flowchart and block diagrams in the Figures illustrate the architecture, functionality, and operation of possible implementations of systems, methods and computer program products according to various aspects of the present disclosure. In this regard, each block in the flowchart or block diagrams may represent a module, segment, or portion of code, which comprises one or more executable instructions for implementing the specified logical function(s). It should also be noted that, in some alternative implementations, the functions noted in the block may occur out of the order noted in the figures. For example, to blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts, or combinations of special purpose hardware and computer instructions.

The terminology used herein is for the purpose of describing particular aspects only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of any means or step plus function elements in the claims below are intended to include any disclosed structure, material, or act for performing the function in combination with other claimed elements as specifically claimed. The description of the present disclosure has been presented for purposes of illustration and description, but is not intended to be exhaustive or limited to the disclosure in the form disclosed. Many modifications and variations will be apparent to those of ordinary skill in the art without departing from the scope and spirit of the disclosure. The aspects of the disclosure herein were chosen and described in order to best explain the principles of the disclosure and the practical application, and to enable others of ordinary skill in the art to understand the disclosure with various modifications as are suited to the particular use contemplated.

Thus, the foregoing description and the accompanying drawings represent non-limiting examples of the methods and apparatus taught herein. As such, the present invention is not limited by the foregoing description and accompanying drawings. Instead, the present invention is limited only by the following claims and their legal equivalents.

What is claimed is:

1. A method implemented in a network monitoring device, the method comprising:
identifying a protocol for communicating with a device communicatively connected to a communications network, wherein identifying the protocol comprises:
sending a request message to a plurality of IP addresses using a plurality of different protocols, wherein each IP address is within a predetermined range of IP addresses, and wherein one of the plurality of IP addresses is assigned to the device;
identifying the protocol based on a response message received from the device;
determining, based on information received in the response message, a memory location at the device that stores metrics data collected by the device;
retrieving the metrics data collected by the device from the memory location; and
determining an identity of the device based on an analysis of the metrics data.

2. The method of claim 1 wherein identifying a protocol for communicating with a device comprises:
associating the response message with the request message that was sent to the device;
determining which of the plurality of protocols was used to send the request message to the device; and
identifying the protocol for communicating with the device as the protocol that was used to send the request message to the device.

3. The method of claim 1 wherein the metrics data comprises a plurality of data point sets, wherein each data point set is stored at a respective memory address at the device, and is associated with a corresponding parameter being measured by the device.

4. The method of claim 3 further comprising configuring a monitoring circuit to retrieve one or more selected data point sets from the device based on the identity and the protocol determined for the device.

5. The method of claim 3 wherein the parameter being measured by the device is a power usage of the device.

6. The method of claim 3 wherein the parameter being measured by the device is a temperature of the device.

7. The method of claim 3 wherein determining an identity of the device based on an analysis of the metrics data comprises:
comparing a selected data point set in the metrics data retrieved from the device to information stored in one or more device profiles, wherein each device profile is associated with a device type;
determining that the selected data point set matches the information stored in a first device profile; and
determining the identity of the device based on the device type associated with the first device profile.

8. The method of claim 7 wherein determining that the selected data point set matches the information stored in a first device profile comprises determining that a type of data represented by the selected data point set matches a corresponding type of data stored in the first device profile.

9. The method of claim 7 wherein determining that the selected data point set matches the information stored in a first device profile comprises determining that one or more data values in the selected data point set matches corresponding one or more data values stored in the first device profile.

10. The method of claim 7 wherein the selected data point set comprises a pattern of data values, and wherein determining that the selected data point set matches the information stored in a first device profile comprises determining that the pattern of data values in the selected data point set matches a corresponding pattern of data values stored in the first device profile.

11. The method of claim 3 wherein determining an identity of the device based on an analysis of the metrics data comprises:
comparing one or more selected data point sets in the metrics data retrieved from the device to corresponding data point sets stored in one or more device profiles, wherein each device profile is associated with a device type;
calculating a similarity score based on a number of the selected data point sets in the metrics data that match the data point sets stored in a first device profile; and
if the similarity score is equal to or exceeds a predetermined threshold score, determining the identity of the device based on the device type associated with the first device profile.

12. A computing device comprising:
a communications interface circuit configured to communicate data with a plurality of devices connected to a communications network; and
a processing circuit configured to:
receive a message from a first device via the communications interface circuit, wherein the message comprises information indicating a memory location storing metrics data collected by the first device;
identify a protocol for communicating with the first device responsive to receiving the message;
retrieve the metrics data collected by the first device from the memory location; and
determine an identity of the first device based on an analysis of the metrics data retrieved from the first device.

13. The computing device of claim 12 wherein to identify a protocol for communicating with the first device, the processing circuit is further configured to:
determine which of one or more request messages that were sent to the first device is associated with the message received from the first device, wherein each of the one or more request messages were sent using a different protocol; and
identify the protocol for communicating with the first device as being the protocol that was used to send the request message to the device.

14. The computing device of claim 12 wherein the metrics data comprises a plurality of data point sets, with each data point set being stored at a respective different memory address, and being associated with a corresponding parameter being measured by the device.

15. The computing device of claim 14 wherein the processing circuit is further configured to configure a monitoring circuit to retrieve one or more selected data point sets from the respective memory addresses based on the identity and the protocol determined for the first device.

16. The computing device of claim 14 wherein the processing circuit is further configured to store a plurality of device profiles in a memory with each device profile comprising one or more reference patterns for a given device type.

17. The computing device of claim 16 wherein each data point set comprises a pattern of data values corresponding to a different parameter being measured by the device, and wherein to determine an identity of the first device, the processing circuit is configured to:
determine that a pattern of data values formed by a selected data point set matches a reference pattern of data values defined in a first device profile;
determine the identity of the first device based on the device type associated with the first device profile.

18. The computing device of claim 16 wherein to determine an identity of the first device, the processing circuit is configured to:
calculate a similarity score indicating how many of a selected number of data point sets match the one or more reference data point sets stored in a first device profile;
if the similarity score is equal to or exceeds a predetermined threshold value, determine the identity of the first device based on the device type associated with the first device profile.

19. The computing device of claim 16 wherein to determine an identity of the first device, the processing circuit is configured to determine whether a type of data represented by a selected data point set matches a type of data represented by a reference data point set in one or more of the plurality of device profiles.

20. A computer readable storage medium comprising computer executable code that, when executed by a processing circuit of a computing device, configures the processing circuit to:
send a request message via a communications network to a destination IP address, wherein the request message is formatted according to a selected protocol; and
determine whether a device associated with the destination IP address has sent a response message in response to the request message, wherein the response message comprises information indicating a memory location at the device;
if the device associated with the destination IP address has sent a response message:
retrieve metrics data from the memory location at the device, wherein the metrics data comprises data points representing selected operating parameters and are collected and stored by the device;
identify the selected protocol used to format the request message as being a protocol for use in communicating with the device; and
determine an identity of the device based on the metrics data retrieved from the memory location at the device.
